(19) United States
(12) Patent Application Publication
(10) Pub. No.: US 2025/0271302 A1
(43) Pub. Date: Aug. 28, 2025

(54) Integrated spectral imaging device with reduced crosstalk

(71) Applicant: The Board of Trustees of the Leland Stanford Junior University, Stanford, CA (US)

(72) Inventor: Thomas Goossens, Amsterdam (NL)

(21) Appl. No.: 18/858,858

(22) PCT Filed: May 13, 2023
(86) PCT No.: PCT/US2023/022174

§ 371 Date: Oct. 22, 2024

Related U.S. Application Data
(60) Provisional application No. 63/341,714, filed on May 13, 2022.

(51) Int. Cl. G01J 3/26; G01J 3/28; G02B 5/28

(52) U.S. Cl. CPC G01J 3/26; G01J 3/2803; G02B 5/284

(57) ABSTRACT

An integrated spectral imaging device has a sensor array comprising image sensor elements; and a filter array comprising Fabry-Perot optical filter elements; where each of the Fabry-Perot optical filter elements is fabricated above one of the image sensor elements; where each of the Fabry-Perot optical filter elements has an optical cavity with an optical path length tuned to a central wavelength; where the Fabry-Perot optical hlter elements are configured such that they are grouped in rectangular cells such that central wavelengths of filter elements within each of the rectangular cells decrease with distance from an optical axis located at a central position in the filter array.

### FIELD OF THE INVENTION

The present invention relates generally to spectral image sensor arrays. More specifically, it relates to patterned arrays of Fabry-Pérot filters.

### BACKGROUND OF THE INVENTION

Spectral imaging devices, using an array of sensors covered by wavelength filters, have many important applications including precision agriculture to monitor large crop fields, early detection of diseases, water stress, nutrient deficiency and soil contamination. Also medical applications are being explored such as imaging burn wounds, detecting skin cancer, analyzing bruises, and endoscopy. In this context, spectral imaging has the advantage of being non-invasive in the sense that no patient samples have to be taken. There is also much potential for industrial quality control such as for foreign material detection (e.g. a stone between nuts), food sorting and quality grading, and detection of bruises in fruit. Among others, there are also applications in recycling, art authentication and preservation, as well as surveillance and counterfeit drug detection. Recently, spectral filters also have been used for building miniature spectrometers which can be integrated in smartphone or other diagnostic devices.

Patterned integration of thin-film Fabry-Pérot filters onto separate image sensor pixels has enabled the miniaturization of spectral cameras. By varying the optical path length of the cavity (e.g., by varying its thickness and/or refractive index), the transmitted wavelength through the filter to each pixel can be tuned. Spectral imaging combines imaging with spectroscopy and creates value by revealing spectral features of spectra that would be obscured by conventional wideband RGB color filters.

An important source of error that plagues most image sensors is some form of pixel crosstalk (electrical or optical) which reduces spatial and spectral resolution. Three forms of crosstalk are typically differentiated: electrical, optical and spectral. Electrical crosstalk is caused by photo-generated electrons that diffuse to neighboring pixels. Optical crosstalk is caused by light arriving at the wrong pixel because, for example, multiple reflections. Spectral crosstalk is caused by imperfections of the filters because they do not suppress strongly enough unwanted wavelengths.

Crosstalk has also been measured for spectral cameras with patterned thin-film filters. This means that the device is not measuring the correct wavelength. Spectral imaging creates value by revealing small spectral features of spectra that would be obscured by typical wideband RGB color filters. Hence, errors caused by crosstalk decrease the commercial value of the camera.

In practice it is difficult to determine the exact cause(s) of crosstalk. Although software corrections that remain agnostic of the cause have been proposed to compensate for crosstalk, this approach does not address the underlying cause. In addition, these methods only partially fix the problem and have to be recalibrated for each new lens.

Understanding the origin of crosstalk could lead to new optimized hardware solutions. For example, the cause of optical crosstalk has previously been attributed to the large distance between the filters and the photodiode in some devices. Hardware solutions include adding physical barriers between filter elements or monolithic integration of the filters onto the photodiode. Despite these efforts, even for cameras with monolithically integrated thin-film filters, significant angle-dependent crosstalk still remains, and is not well understood.

### BRIEF SUMMARY OF THE INVENTION

The inventor has discovered, analyzed, and developed new filter array patterns to mitigate a type of optical crosstalk unique to patterned thin-film filters. Unlike conventional RGB color filters which are absorption filters, thin-film Fabry-Pérot filters have a distinct type of crosstalk due to the presence of highly reflective mirrors which form an optical cavity between which light can remain trapped. The crosstalk mechanism described in this disclosure is that the Fabry-Pérot filters act as coupled waveguides that can propagate optical signals above the pixel array. The inventor discovered that the crosstalk between two adjacent filters can be asymmetrical, i.e., that it has dependence upon the direction of the incident light. This enables elimination of the crosstalk by rearranging the filters on the sensor. This is an inexpensive solution that can be easily implemented using existing fabrication techniques. In contrast, prior solutions to eliminate other forms of crosstalk involve adding physical barriers that prevent the light from leaking, which involves additional expensive wafer processing steps.

In one aspect, the invention provides an integrated spectral imaging device comprising: a sensor array comprising image sensor elements; and a filter array comprising Fabry-Pérot optical filter elements; wherein each of the Fabry-Pérot optical filter elements is fabricated above one of the image sensor elements; wherein each of the Fabry-Pérot optical filter elements has an optical cavity with an optical path length tuned to a central wavelength; wherein the Fabry-Pérot optical filter elements are configured such that they are grouped in rectangular cells such that central wave-lengths of filter elements within each of the rectangular cells decrease with distance from an optical axis located at a central position in the filter array.

Preferably, the cavity has a thickness and a refractive index selected to tune the optical path length of the cavity to the central wavelength. In some implementations, the central wavelengths of the filter elements within each of the rectangular cells decrease with distance from the optical axis along two orthogonal axes within a plane of the filter array. In other implementations, the central wavelengths of the filter elements within each of the rectangular cells decrease with distance from the optical axis along at least one of two orthogonal axes within a plane of the filter array.

Preferably, each of the rectangular cells has at least two filters along each side. In preferred implementations, adjacent filters in the rectangular cells have distinct central wavelengths.

In some implementations, the Fabry-Pérot optical filter elements are substantially contiguous, and wherein the image sensor elements are substantially contiguous. In other implementations, the Fabry-Pérot optical filter elements are configured with gaps between adjacent elements, wherein the gaps are at most 1 μm to 1 mm, depending on the implementation.

Preferably, each of the image sensor elements has a shortest dimension no more than 100 μm wide. In some implementations, each of the Fabry-Pérot optical filter elements is fabricated above a plurality of the image sensor elements. In other implementations, each of the Fabry-Pérot optical filter elements is fabricated above a single image sensor element.

In some implementations, each of the Fabry-Pérot optical filter elements has multiple optical cavities. In other implementations, each of the Fabry-Pérot optical filter elements has a single optical cavity.

### BRIEF DESCRIPTION OF THE SEVERAL VIEWS OF THE DRAWINGS

FIG. 1A is a cross-sectional diagram of two neighboring all-dielectric Fabry-Pérot filters in a sensor array.

FIG. 1B shows an equivalent parallel plate waveguide model of the two adjacent filters of FIG. 1A.

FIGS. 2A, 2B, 2C show graphs of FDFD simulations of adjacent filters, where FIG. 2A shows crosstalk continuing to propagate to the right, FIG. 2B shows crosstalk dies out quickly to the left, and FIG. 2C shows crosstalk propagates again to the left for large angles.

FIG. 3 is a dispersion diagram for an equivalent waveguide model of adjacent filters.

FIG. 4 is a graph of asymmetrical power flux across the vertical boundary between the two filters.

FIGS. 5A, 5B, 5C illustrate three filter patterns A, B, C, respectively, with corresponding graphs of transmittance, where Pattern A is shown in FIG. 5A, Pattern B is shown in FIG. 5B, and Pattern C is shown in FIG. 5C.

FIGS. 6A, 6B show side views of two filter patterns on a sensor array, where FIG. 6A shows a staircase pattern and FIG. 6B shows a rumba sleeve pattern.

FIGS. 7A, 7B show top views of example sensor arrays with different filter patterns, where FIGS. 7A shows a pattern of different filters repeated uniformly throughout the entire sensor array and FIGS. 7B shows a crosstalk eliminating pattern according to an embodiment of the invention, where the filters in each cell of the pattern are arranged to decrease in thickness with increasing distance from the optical axis at the center of the array.

FIG. 8 illustrates two neighboring parallel plate waveguides with different thicknesses.

FIG. 9 illustrates a configuration of two adjacent parallel plate waveguides, where crosstalk occurs towards a thinner filter.

FIG. 10A shows graphs at different incident angles of transmittance spectra showing crosstalk asymmetry of left-to-right (top) vs right-to-left (bottom).

FIG. 10B shows a graph of relative height of crosstalk peak transmittance.

FIG. 11 shows a graph of an FDFD simulation domain with nine adjacent Fabry-Pérot filters on a single substrate.

FIG. 12 shows a graph of an FDFD simulation domain with nine adjacent Fabry-Pérot filters on a single substrate.

FIG. 13 are graphs showing transmittance of each filter illuminated at incident angles of 15° (pattern A) and −15° (pattern B).

### DETAILED DESCRIPTION OF THE INVENTION

Embodiments of the present invention provide spectral image sensors based on patterned thin-film Fabry-Pérot filters that overcome crosstalk problems of prior devices.

The design of these devices is based on two surprising properties of optical crosstalk between adjacent patterned thin-film filters. First, crosstalk between adjacent filters can be asymmetrical with respect to direction of incident light, allowing for low-cost crosstalk elimination by rearranging the filter pattern on the sensor. Second, eliminating crosstalk to all neighbors-instead of a subset-is a suboptimal solution. These findings are counterintuitive from a ray perspective, as nothing would seemingly stop rays from entering the neighboring cavity. However, the observations may be understood by treating the patterned filters as coupled waveguides that can propagate crosstalk above the pixels.

The investigation starts by analyzing the crosstalk between two neighboring filters and then proceeds to compare different filter patterns.

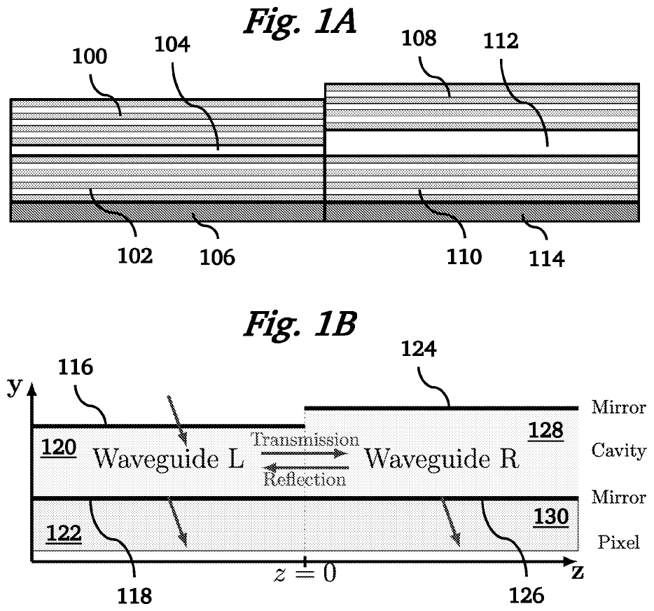

FIG. 1A is a cross-sectional diagram of two neighboring all-dielectric Fabry-Pérot filters in a sensor array. The left (L) and right (R) filters both are of a typical dielectric Fabry-Pérot design having multiple layers. The left filter has an optical cavity 104 sandwiched between a top quarter-wave stack 100 and a bottom quarter-wave stack 102. The left filter is fabricated above a left sensor pixel 106. Similarly, the right filter has an optical cavity 112 sandwiched between a top quarter-wave stack 108 and a bottom quarter-wave stack 110. The right filter is fabricated above a right sensor pixel 114. It is noted that the right cavity 112 is thicker than the left cavity 104.

The structure of each filter can be represented as follows:

Air|HLHLHLHLH|L_{cavity}|HLHLHLHLH|Silicon,

with n_{L}=1.5 and n_{H}=2.4. H and L indicate a quarter wave thickness for λ=720 nm and the cavity thickness is defined as L_{cavity}=2L+δ. Taking δ_{L}=0 nm and δ_{R}=30 nm, the filters have central wavelengths λ_{cwl}^{L}=720 nm and λ_{cwl}^{R}=753 nm respectively, at normal incidence; all wavelengths are specified in vacuum. The electromagnetic field in this structure is simulated using a finite difference frequency domain approach (FDFD).

To interpret the numerical results as a coupled waveguide phenomenon, the crosstalk between Fabry-Pérot filters is modeled as a coupling problem between parallel plate waveguides. Each filter is considered as a horizontal waveguide with a single layer sandwiched between highly reflective mirrors. FIG. 1B shows an equivalent parallel plate waveguide model of the two adjacent filters of FIG. 1A. The left waveguide is formed by a cavity 120 defined by a top mirror 116 and bottom mirror 122 above a pixel 122. The right waveguide is formed by a cavity 128 defined by a top mirror 124 and bottom mirror 126 above a pixel 130.

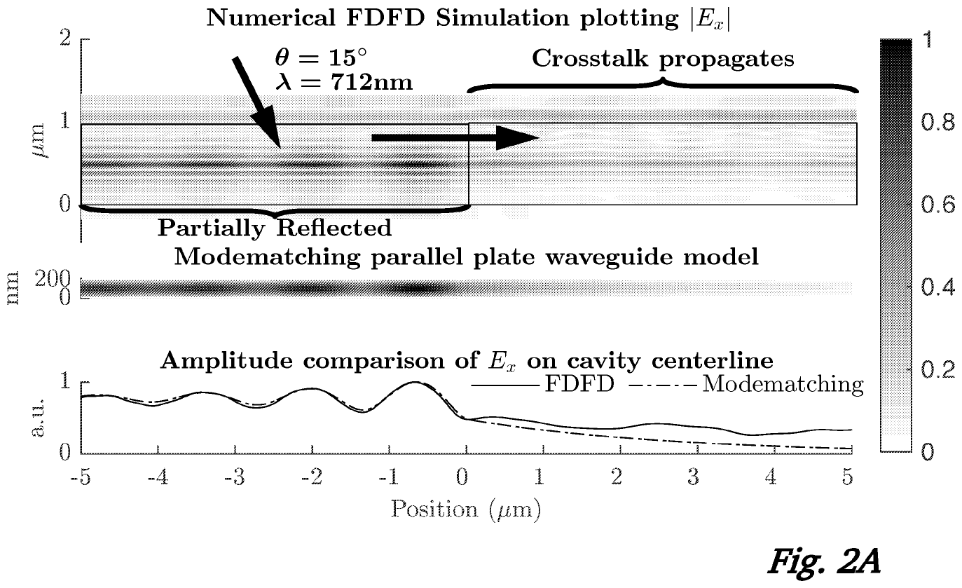

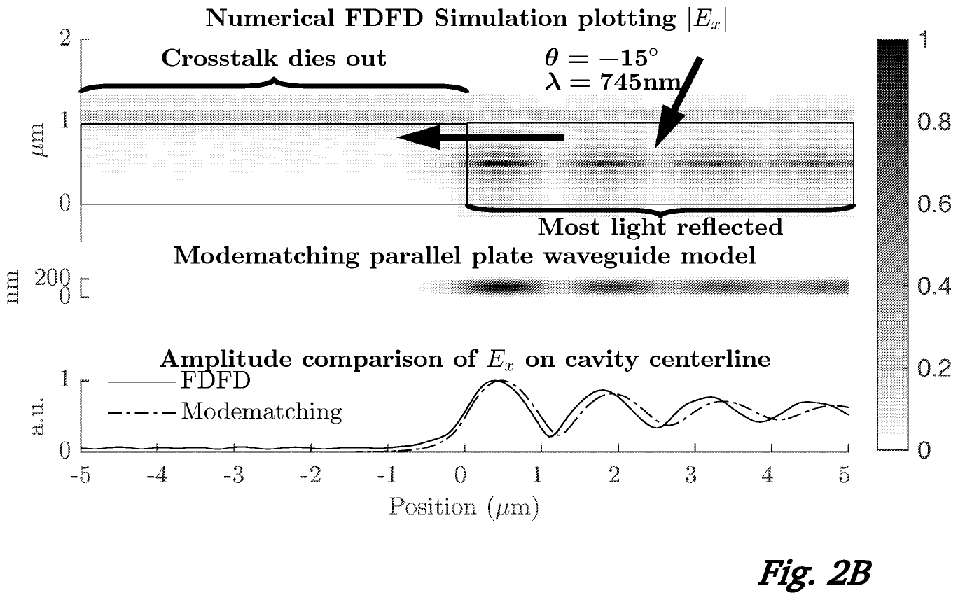

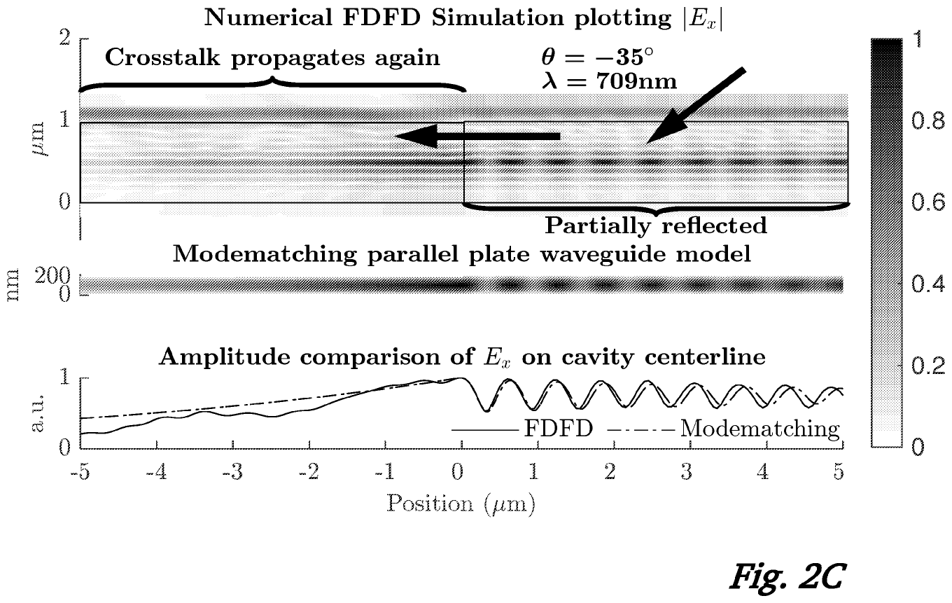

Using an effective refractive index (n_{eff}^{L} and n_{eff}^{R}) and effective thickness this simple model accounts for the spatial extent of the modes across multiple layers in the stack (see FIGS. 2A, 2B, 2C). In general, the effective thickness and refractive index are not equal to the corresponding quantities of the cavity layer in the stack. For a filter of given central wavelength, its effective half-wave thickness equals

$${h}_{eff}^{L , R} = {λ}_{cwl}^{L , R} / 2 {n}_{eff}^{L , R} . \qquad ( 1 )$$

For perfectly reflective mirrors, the tangential electrical fields have to be zero at the edge and have sinusoidal profiles. The modal expansions of the incident, reflected, and transmitted field for the TE mode are of the form:

$${E}_{x} ( y , z ) = {\sum }_{m = 1} {a}_{m} sin ( {γ}_{m} y ) {e}^{\pm i {β}_{m} z} . \qquad ( 2 )$$

For the purpose of this description, only the fundamental modes (m=1) are discussed. The propagation factors for the left (L) and right (R) filters are

$${β}_{L , R} = \sqrt{{( \frac{2 π {n}_{eff}^{L , R} f}{c} )}^{2} - {γ}_{L , R}^{2}} , \qquad ( 3 )$$

$${γ}_{L , R} = π / {h}_{eff}^{L , R} ,$$

with f[s⁻¹] the frequency of the light and c the speed of light. Mode matching is performed at the interface at z=0, imposing continuity of the tangential field components. In what follows we will compare the FDFD simulations with the mode matching model.

FIGS. 2A, 2B, 2C show graphs of FDFD simulations to investigate the amount of crosstalk for positive and negative incidence angles, where FIG. 2A shows crosstalk continuing to propagate to the right, FIG. 2B shows crosstalk dies out quickly to the left, and FIG. 2C shows crosstalk propagates again to the left for large angles. The darker regions in the figure correspond to larger modulus of the complex field Eₓ. In all cases, the equivalent waveguide model (mode matching) corresponds well to the numerical simulation. All plotted values are normalized by the peak electrical field value.

First we investigate how light leaks from the Left (L) to the Right (R) filter for an incident plane wave at an angle θ=+15° with respect to the normal and with wavelength λ=712 nm, which is the peak transmitted wavelength of the left filter at this angle. The main observation is that light from the Left cavity continues to propagate in the Right cavity, as shown in FIG. 2A. The amplitude of the complex tangential field Eₓ dies out slowly because the mirrors have less than unit reflectance. Light is also partially reflected back at the interface causing an interference pattern in the Left (L) filter.

The equivalent waveguide model correctly predicts the propagation of crosstalk and the interference pattern.

Something peculiar happens when the experiment of FIG. 2A is repeated for a negative incidence angle: from the Right to the Left filter for an incident plane wave at −15°. We use a wavelength λ=745 nm, which is the peak transmitted wavelength of the right filter at this angle. Now, the crosstalk dies out quickly instead of propagating, that is, it appears evanescent, as shown in FIG. 2B. Correspondingly, most of the light is reflected back into the right filter. This can be seen from the fact that there are almost perfect nodes (shown in the figure as white) in the standing wave pattern, indicating destructive interference with a wave of similar amplitude. Interestingly, for θ=−35°, crosstalk propagates again, as shown in FIG. 2C. The equivalent model predicts similar behavior, anew confirming the coupled waveguide interpretation.

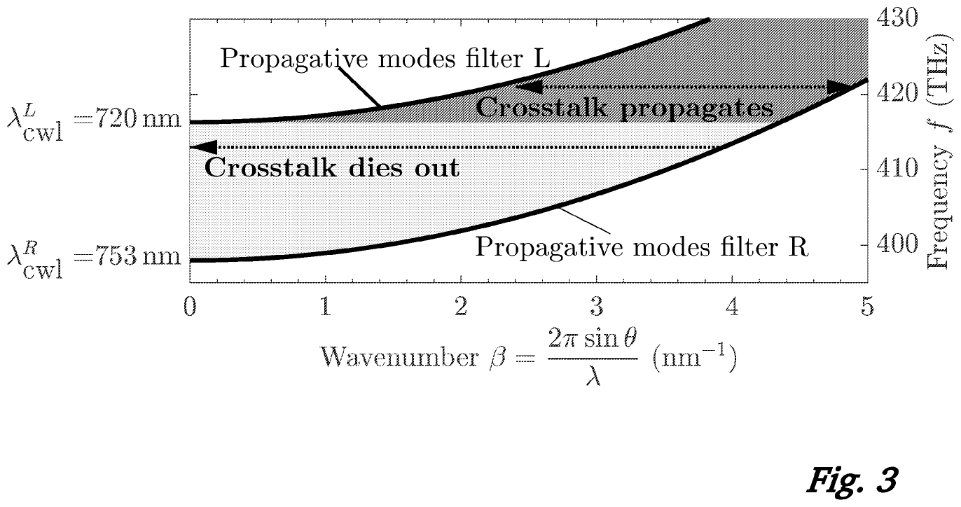

The observations in the above three experiments are not a coincidence but rather the rule. The explanation is that not all frequencies can excite propagative modes in any waveguide. Below the so-called cutoff frequency, the propagation constant β becomes imaginary and the mode dies out exponentially in space (evanesces). The configurations in which crosstalk propagates or dies out can be visualized with a dispersion diagram, commonly used in waveguide analysis. FIG. 3 is a dispersion diagram for the equivalent waveguide model. For light of a given frequency to be able to propagate in a neighboring filter, one must be able to draw a horizontal line that intersects both black curves. Ignoring the finite bandwidth of the filters, the graph shows two black curves which represent the propagative modes that each filter/waveguide can sustain. For light of a given frequency to be able to propagate in a neighboring filter, this filter must be able to sustain a mode of that frequency, i.e., one must be able to draw a horizontal line on FIG. 3 that intersects both curves. In the light gray region, no such intersection exists and crosstalk (from the Right (R) to the Left (L) filter) dies out. In the dark gray region, intersections exists and crosstalk can propagate bidirectionally.

The dispersion diagram can also be analyzed in terms of the angle of incidence θ onto the filters with respect to the normal. For narrowband filters, the peak transmitted frequency rises with the angle of incidence, as seen in FIG. 3. Above a certain cutoff angle θ_{c}, the frequency of the light originating in the “from” cavity will be larger than the cutoff frequency of the receiving “to” cavity which can now sustain a propagative mode. It can be derived that, approximately, crosstalk is only eliminated when the incidence angle θ satisfies (see Supplemental Document)

$$\vert θ \vert < {θ}_{c} = Re [ a sin ( {n}_{eff}^{from} \sqrt{{[ \frac{{λ}_{cwl}^{from}}{{λ}_{cwl}^{to}} ]}^{2} - 1} ) ] . \qquad ( 4 )$$

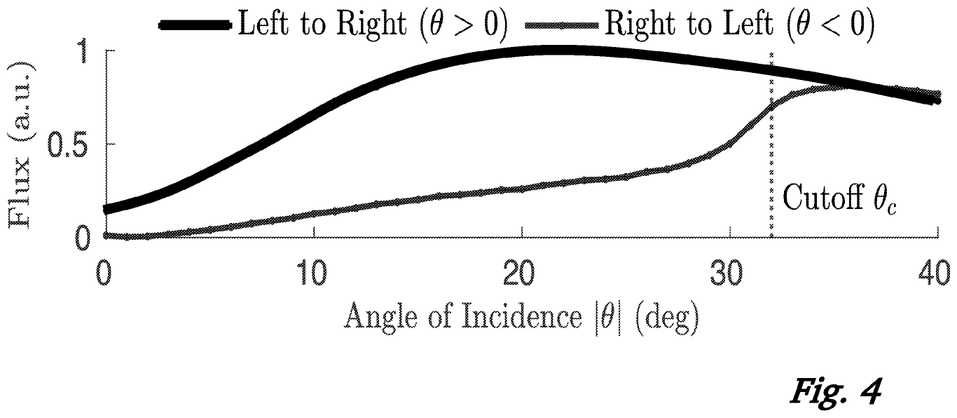

From this equation it also follows that, cavity crosstalk can be only eliminated through evanescence when it leaks towards a filter with a shorter central wavelength (λ_{cwl}^{from}>λ_{cwl}^{to}), when only considering the fundamental modes. In the above calculations, the central wavelengths λ_{cwl}^{to,from} are defined as the peak transmitted wavelengths at normal incidence. For the guiding example in FIG. 1A the cutoff angle is θ_{c}=31.37° (n_{eff}=1.7). This asymmetry is observed when plotting the angular dependency of the power flux across the vertical boundary between the two filters. FIG. 4 is a graph of asymmetrical power flux across the vertical boundary (at z=0) between the two filters from FIG. 1A. The asymmetry in flux quickly dissapears around the predicted cutoff angle θ_{c}≈31° (see Eq. (52) . For each angle, the power flux was calculated for the peak transmitted wavelength of the originating filter.

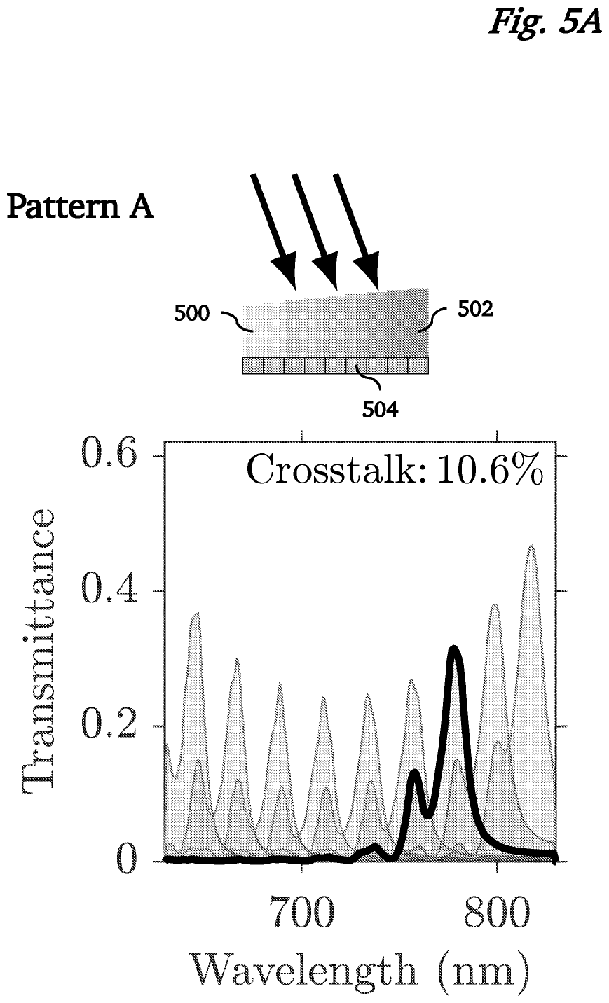

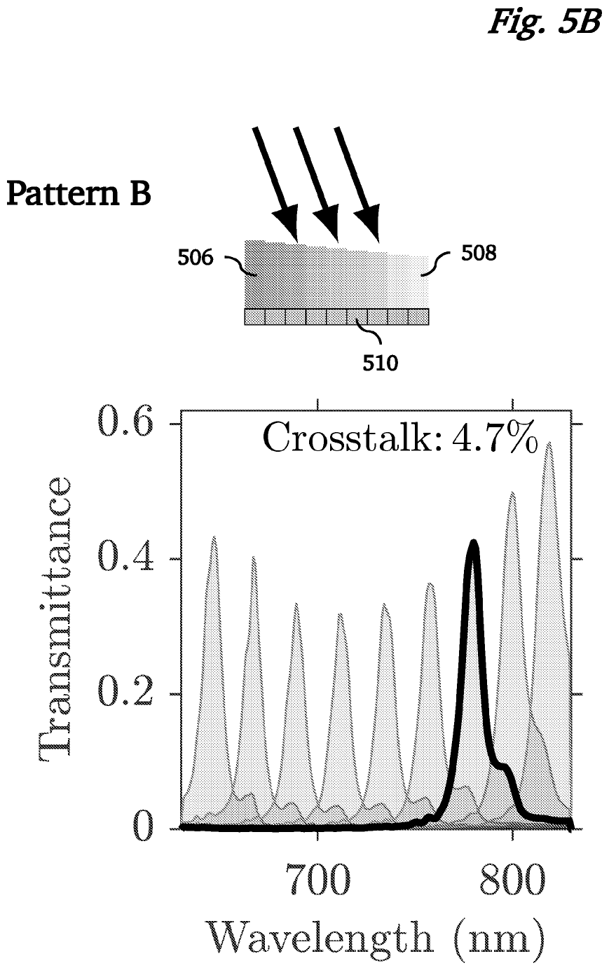

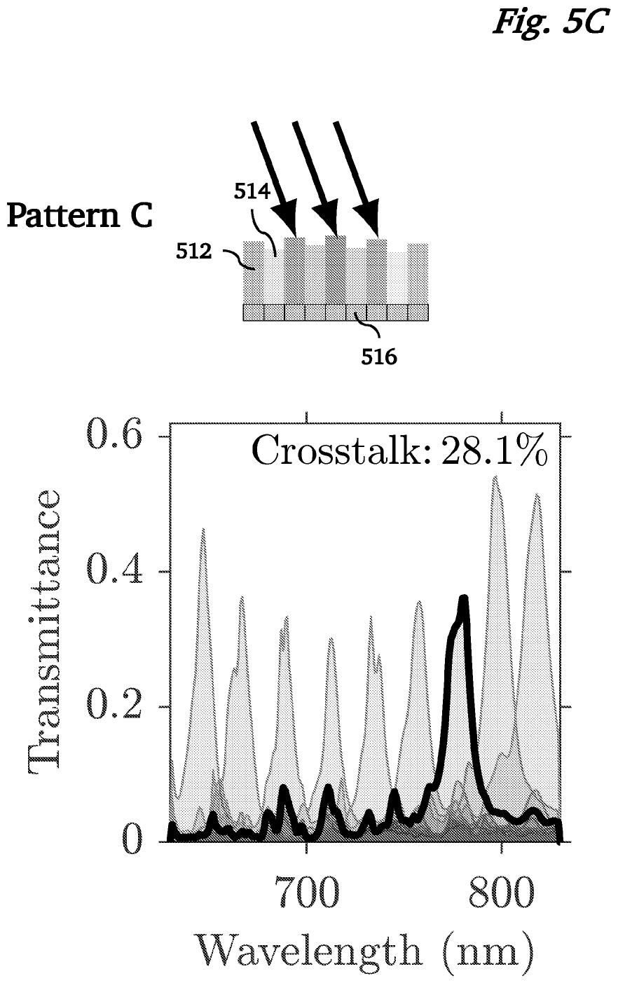

The filters on a sensor can nowadays be arranged in arbitrary patterns. To investigate which patterns perform best (less crosstalk), the transmittance of nine neighboring 5 μm wide thin-film filters is simulated. The simulation is repeated for three filter patterns: A, B, and C, all of which are illuminated with collimated light (i.e., a plane wave) at an incident angle of θ=15°. FIGS. 5A, 5B, 5C illustrate these three filter patterns A, B, C, respectively, and corresponding graphs of transmittance simulated for three filter patterns for collimated light at 15 degrees. Pattern A (FIG. 5A) shows one cell of the pattern, where filters 500 through 502 are arranged, left to right, in ascending order (i.e., increasing thickness, tuned to shorter to longer wavelengths) and fabricated above sensor pixels 504. Pattern B (FIG. 5B) shows one cell of the pattern, where filters 506 through 508 are arranged, left to right, in descending order (i.e., decreasing thickness, tuned to shorter to longer wavelengths) and fabricated above sensor pixels 510. Pattern C (FIG. 5C) shows one cell of the pattern, where all adjacent filters such as 512 and 514 are arranged to have large differences in thickness, tuned to significantly different wavelengths, and fabricated above sensor pixels 516. Pattern C attempts crosstalk elimination in any direction by maximizing height differences (to achieve mode mismatch).

Pattern B shows 4.7% crosstalk, while pattern A has larger 10.6% crosstalk. Pattern B has a higher peak transmittance than pattern A. Pattern C has more crosstalk (28.1%) of a different kind. The crosstalk is estimated as the percentage of its contribution to the area of the transmittance curve by comparison with a Lorentzian fit of the main peak.

As expected from Eq. (52), filter pattern B shows less crosstalk (smaller side bumps) than pattern A. Surprisingly, pattern C has more, yet qualitatively different, crosstalk. The transmittance peaks have longer tails modulated by additional resonances that are uncorrelated to the neighboring filter wavelengths. Since cavity crosstalk is eliminated by means of reflection, the hypothesis is that the reflections on both filter boundaries generates a horizontal low-finesse Fabry-Pérot resonator which enhances additional undesired wavelengths. This indicates that eliminating cavity crosstalk on all sides of a filter is undesirable for, at least, the simulated pixel width.

The above analysis suggests that in an imaging sensor array, the occurrence of pattern B should be maximized and the resonances caused by pattern C avoided. Near the optical axis (i.e., at the center of the array) the focused beam is rotationally symmetric and the crosstalk asymmetry cannot be exploited. Yet, Pattern C can still be avoided by choosing either pattern A or B. For non-telecentric lenses, the further the pixel from the optical axis, the more the focused beam is skewed such that the asymmetry can be exploited. The relevance of this solution will depend on the f-number and chief ray angle. In what follows, improvements are provided for patterns that are commonly used for spectral imaging: the staircase and mosaic pattern.

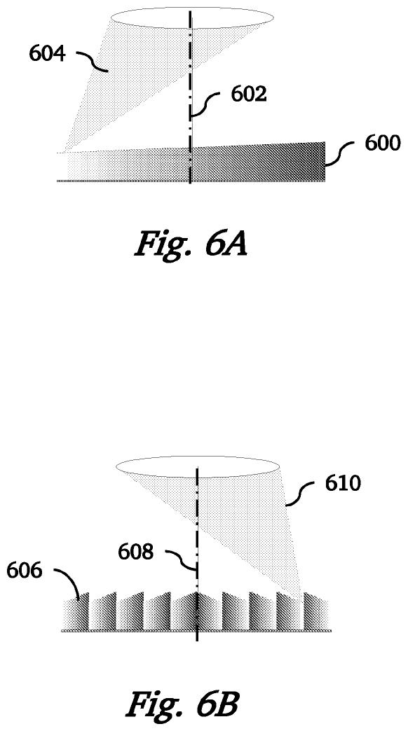

FIGS. 6A, 6B show side views of two filter patterns on a sensor array. FIG. 6A shows a staircase pattern with filters 600 increasing in thickness across the entire width of the array. Also shown are the optical axis 602 and incident light 604. Note that, moving away from the optical axis, the filter thickness increases to the right but decreases to the left. FIG. 6B shows a mirrored sawtooth pattern that we call a “rumba sleeve” pattern with filters 606 in each cell, where the central wavelength is indicated by the shade of gray. Also shown are the optical axis 608 and incident light 610. Note that, moving away from the optical axis in either direction, the filter thickness within each cell decreases in thickness. By mostly descending in both directions away from the optical axis, the rumba pattern is expected to reduce more crosstalk than the staircase pattern (see Pattern A vs. B in FIGS. 5A, 5B). The filters are not drawn to scale for visual effect only. Visually, each filter extends into the page across the whole sensor.

For the staircase pattern, each filter covers an entire row of pixels and the camera requires a translation motion. While crosstalk within a single row of identical filters will always propagate, we can still reduce crosstalk between distinct rows. In the staircase arrangement, with respect to the optical axis in the center of the pattern, half of the filters would see propagating crosstalk. This could be addressed by a permutation into triangle. However, because of the possibly very gradual change in thickness, the cutoff angle θ_{c} might be too small and the filters might significantly overlap spectrally. The step size is increased by rearranging the filters into the rumba sleeve pattern. Optionally, one only implements this near the sensor edge where incidence angles are typically largest.

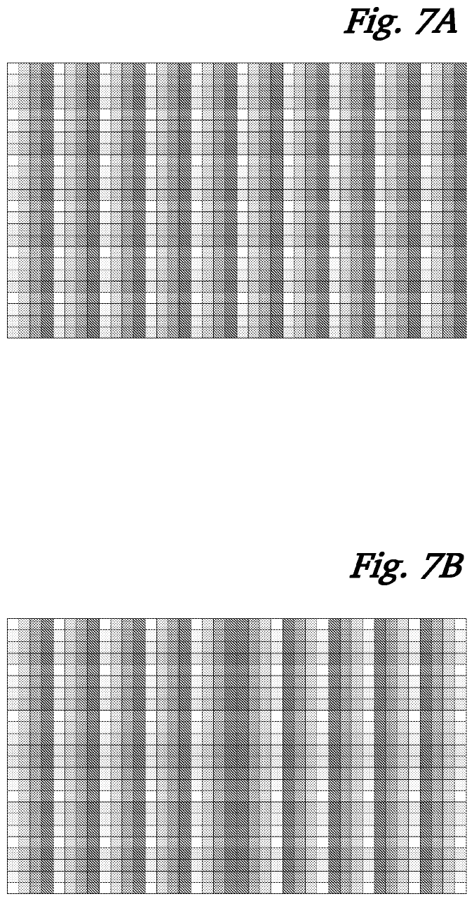

FIGS. 7A, 7B show top views of example sensor arrays with different mosaic patterns for snapshot spectral imaging. Shading indicates cavity thickness. The optical axis is at the center of the array. The cell size of 4×4 is used as an example for illustrative purposes only. FIGS. 7A shows a typical pattern where each cell contains a pattern of different filters repeated uniformly throughout the entire sensor array. For this mosaic pattern, a cell of N×N filters are periodically repeated across the sensor, which enables snapshot imaging. More generally, the cells can have N×M filters, with N, M≥2. FIGS. 7B shows a crosstalk eliminating pattern according to an embodiment of the invention, where the filters in each cell of the pattern are arranged to decrease in thickness with increasing distance from the optical axis at the center of the array. The filters are in descending thickness/wavelength pointing away from the optical axis. This can be implemented, for example, by rotating a pattern concentrically around the optical axis, so the rotational orientation of the pattern of a cell depends on which quadrant of the array the cell is positioned in.

An actual camera implementation can demonstrate the effectiveness of this approach with focused light. In addition, there can be other dominant forms of optical and electrical crosstalk for a particular sensor. Determining which form of crosstalk dominates, however, often remains in the realm of speculation. Fortunately, cavity crosstalk has two distinct properties that can be experimentally verified for existing commercial devices: for small differences in central wavelength there is an asymmetry and a cutoff incidence angle above which crosstalk becomes bidirectional again. A tilt experiment with collimated light might thus be used to assess the significance of cavity crosstalk.

Finally, there are various alternative implementations envisioned by the inventor. First, potential alternatives to eliminate cavity crosstalk include tuning the reflection coefficients between the waveguides, vertically misaligning the cavities or adding air gaps between the filters. Second, the strategy to maximize the amount of evanescent crosstalk remains, in principle, valid for any filter that has waveguide-like behavior. Examples include single cavity filters that modulate the cavity refractive index, cavities with sub-wavelength gratings, and multi-cavity filters. In addition, the presented modal coupling analysis could be generalized to multiple harmonics but might yield different elimination strategies. Finally, as the amount of crosstalk is determined at the interface, it is mostly independent of filter size. However, smaller pixels collect less light, making the relative contribution of crosstalk large. In addition, for tiny pixels crosstalk might propagate through multiple neighboring filters as already observed for Pattern A (FIG. 5A).

In conclusion, the above analysis shows and explains that optical cavity crosstalk can be asymmetrical. This insight provides the basis for sensor device designs that allow crosstalk to be reduced by specific arrangements of the filters on the sensor. This is a simple low-cost solution compared to adding physical barriers. Interestingly, eliminating crosstalk on all sides of a filter seems suboptimal due to additional resonances. This effect may turn out to be of more importance than cavity crosstalk itself. These findings reveal untapped opportunities for developing better sensors.

### Crosstalk as a Coupled Waveguide Problem

In the following sections we provide additional theoretical details and analysis to guide the design of sensors according to the principles of the present invention.

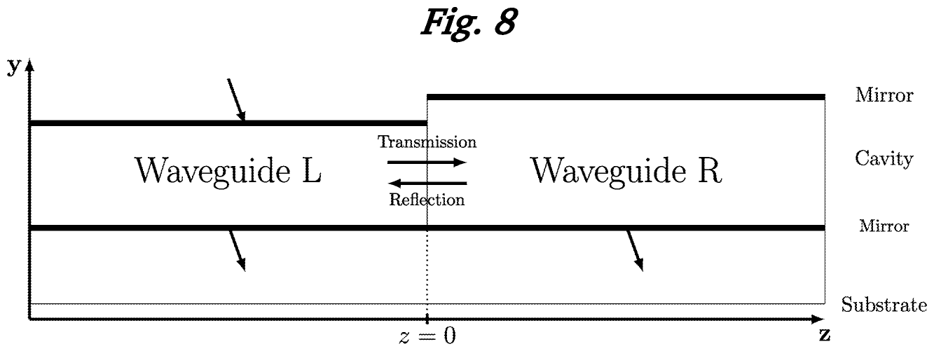

This disclosure studies crosstalk between patterned thin-film Fabry-Pérot filters. To interpret the numerical simulations, they are compared to an equivalent parallel plate waveguide model. Each filter is considered as a horizontal waveguide with a single layer sandwiched between two highly reflective mirrors. FIG. 8 illustrates two neighboring parallel plate waveguides, L and R, with a different thickness. Each waveguide is a cavity sandwiched between two mirrors, and fabricated above a substrate.

Each slab has an effective refractive index (n_{eff}^{L}=1.7 and n_{eff}^{R}=1.7) and a corresponding effective slab thickness

$${h}_{eff}^{L , R} = {λ}_{cwl}^{L , R} / 2 {n}_{eff}^{L , R} , \qquad ( 5 )$$

acting as a halve-wave plate for a given central (transmitted) wavelength λ_{cwl}.

Light enters from the top and and couples to modes in the cavity. These modes travel horizontally through the cavity until they reach the boundary of a neighboring filter. At the boundary, light scatters: it partially reflects and partially transmits. Crosstalk is eliminated if most light is reflected (low transmission).

We start by describing the set of modes that can exist in each filter. The coefficients of these modes are then found by imposing continuity at the boundary; a procedure called mode matching.

### Modal Expansions in the Cavity

We start by considering the case of a perfect parallel plate waveguide for the TE mode (Eₓ, H_{y}, H_{z}). In this case, electrical field Eₓ has to be zero at the mirrors. From the Helmholtz equation it then follows that the modes are sinusoidal so that

$${E}_{x}^{i} ( y , z ) = {\sum }_{m = 1}^{M} {a}_{m} sin ( {γ}_{m} y ) {e}^{- i {β}_{m} z} , \qquad ( 6 )$$

$${E}_{x}^{r} ( y , z ) = {\sum }_{m = 1}^{M} {r}_{m} sin ( {γ}_{m} y ) {e}^{+ i {β}_{m} z} , \qquad ( 7 )$$

$${E}_{x}^{t} ( y , z ) = {\sum }_{m = 1}^{M} {t}_{m} sin ( {γ}_{m}^{′} y ) {e}^{- i {β}_{m}^{′} z} , \qquad ( 8 )$$

$$with$$

$${γ}_{m} = \frac{m π}{{h}_{eff}} , {β}_{m} = \sqrt{{( \frac{ω}{c} )}^{2} - {γ}_{m}^{2}} , \qquad ( 9 )$$

$${γ}_{m} = \frac{m π}{{h}_{eff}} , {β}_{m}^{′} = \sqrt{{( \frac{ω}{c} )}^{2} - {γ}_{m}^{′ 2}} . \qquad ( 10 )$$

and with aₘ, rₘ, and t′ₘ being the modal expansion coefficients.

By design, Fabry-Pérot filters have less than unit reflectance R, otherwise no light would ever enter or exit the cavity. When illuminated by a finite beam, the buildup of the field in the cavity is described by an exponential: (∝(1−e^{αz}). The α parameter depends on the mirror reflectance R and can be estimated from geometrical reasoning.

Here, we use a similar approach to estimate the exponential attenuation e^{-αz} of the modes, rather than their buildup. The decay parameter α is estimated by calculating the attenuation of a ray. At each reflection, a ray's complex amplitude is attenuated by a factor r=\sqrt{R}. For this ray interpretation to be consistent with the wave interpretation, the exponential attenuation should equal r after one cavity traversal so that

$${e}^{- α {Δ}_{x}} = \sqrt{R} , \qquad ( 11 )$$

with Δₓ=h_{eff}tan θₙ being the horizontal displacement for a single traversal. Finally, we have that

$$α = \frac{- log \sqrt{R}}{{h}_{eff} tan ( {θ}_{n} )} . \qquad ( 12 )$$

The reflectance is R=0.9744.

Assuming the modes are attenuated by mirror loss we obtain

$${E}_{x}^{i} ( y , z ) = {\sum }_{m = 1}^{M} {a}_{m} sin ( {γ}_{m} y ) {e}^{- i {β}_{m} z} , \qquad ( 13 )$$

$${E}_{x}^{r} ( y , z ) = {\sum }_{m = 1}^{M} {r}_{m} sin ( {γ}_{m} y ) {e}^{+ i {β}_{m} z} {e}^{α z} , \qquad ( 14 )$$

$${E}_{x}^{t} ( y , z ) = {\sum }_{m = 1}^{M} {t}_{m} sin ( {γ}_{m}^{′} y ) {e}^{- i {β}_{m}^{′} z} {e}^{- α z} , \qquad ( 15 )$$

It are these sets of modes that will be matched that the interface.

### Mode Matching at the Interface

The tangential electrical and magnetic field should be continuous across the interface between the two filters at z=0. The two boundary conditions are:

$${{Boundary Condition 1 : {E}_{x}^{i} + {E}_{x}^{r} \vert}_{z = 0 -} = {E}_{x}^{t} \vert}_{z = 0 +} , \qquad ( 16 )$$

$${{Boundary Condition 2 : {H}_{y}^{i} + {H}_{y}^{r} \vert}_{z = 0 -} = {H}_{y}^{t} \vert}_{z = 0 +} . \qquad ( 17 )$$

We assume that the magnetic permeability is equal in both waveguides. For the TE mode (Eₓ, H_{y}, H_{z}), we can then rewrite the second condition as the continuity of the electrical field derivative:

$${{Reformulated Boundary Condition 2 : \frac{\partial ( {E}_{x}^{i} + {E}_{x}^{r} )}{\partial z} \vert}_{z = 0 -} = \frac{\partial {E}_{x}^{t}}{\partial z} \vert}_{z = 0 +} , \qquad ( 18 )$$

as follows from applying the curl equation

$$∇ \times E = - μ \frac{\partial H}{\partial t} ,$$

with μ the magnetic permeability. A similar argument for the TM mode (Hₓ, E_{y}, E_{z}) would only work when there is no change in electrical permittivity. This is the case for the thickness modulated filters used in this work, but would not apply for index-modulated.

These boundary conditions only specify the field at the cross-section (0<x<min(h_{eff}, h′_{eff})). The thicker cavity, however, extends beyond this shared cross-section and we need to make an assumption about the field at z=0. Without further proof, it is assumed that this section is also perfectly reflective and hence

$${E}_{x} ( x , z = 0 ) = 0 , for min ( {h}_{eff} , {h}_{eff}^{′} ) < x < max ( {h}_{eff} , {h}_{eff}^{′} ) . \qquad ( 19 )$$

This assumption produces a good match with the FDFD calculation for the cases simulated in the paper.

The organization of the derivation is as follows. First, mode matching is applied for when the right (receiving) cavity is thicker. Second, mode matching is applied for a thinner right cavity. The difference between the two cases is the side at which the interface extends beyond the shared cross-section, because one filter is thicker (see Eq. (19)). Lastly, applying all boundary conditions leads to the formulation linear systems whose solutions are the required coefficients for both cases.

### Mode Matching Derivation: Towards Thicker Cavity

### Boundary Condition 1: Continuity of the Electrical Field

Substituting the modal expansions in the boundary condition gives

$${\sum }_{m = 1}^{M} {t}_{m} sin ( {γ}_{m}^{′} y ) = \{ \begin{matrix}{\sum }_{m = 1}^{M} ( {a}_{m} + {r}_{m} ) sin ( {γ}_{m} y ) & 0 < x < {h}_{eff} \\ 0 & else Eq . ( 19 )\end{matrix} . \qquad ( 20 )$$

For convenience an identical number of modes M on both sides is chosen.

We proceed by multiplying both sides by

$$\frac{2}{{h}_{eff}^{′}} sin ( {γ}_{k}^{′} y )$$

and integrating across [0, h′_{eff}]. We have to integrate across the full height of the thicker filter to fully enforce Eq. (20). We obtain

$${\sum }_{m = 1}^{M} {t}_{m} \frac{2}{{h}_{eff}^{′}} {\int }_{0}^{{h}_{eff}^{′}} sin ( {γ}_{m}^{′} y ) sin ( {γ}_{k}^{′} y ) dy = {\sum }_{m = 1}^{M} ( {a}_{m} + {r}_{m} ) \frac{2}{{h}_{eff}^{′}} {\int }_{0}^{{h}_{eff}} sin ( {γ}_{m} y ) sin ( {γ}_{k}^{′} y ) dy . \qquad ( 21 )$$

On the right we only integrate from 0 to h_{eff} because, by construction, the integrand is zero outside this region (Eq. (20)).

Orthogonality of the eigenmodes implies

$$\frac{2}{{h}_{eff}^{′}} {\int }_{0}^{{h}_{eff}^{′}} sin ( {γ}_{m}^{′} y ) sin ( {γ}_{k}^{′} y ) dy = \{ \begin{matrix}1 & n = k \\ 0 & n \neq k\end{matrix} . \qquad ( 22 )$$

It follows that the transmission coefficients can be written as

$${t}_{k} = {\sum }_{m = 1}^{M} ( {a}_{m} + {r}_{m} ) {\underbrace{\frac{2}{{h}_{eff}^{′}} {\int }_{0}^{{h}_{eff}} sin ( {γ}_{m} y ) sin ( {γ}_{k}^{′} y ) dy}}_{{l}_{km}} . \qquad ( 23 )$$

The elements lₖₘ can be computed numerically and organized in a matrix L₁. In matrix notation, we obtain the following linear equation:

$$t = {L}_{1} ( a + r ) . \qquad ( 24 )$$

with a, r, and t M-dimensional vectors containing the modal expansion coefficients.

### Boundary Condition 2: Continuity of the Electrical Field Derivative

Substituting the modal expansions into the second boundary condition gives

$${{\frac{\partial {E}_{x}^{t}}{\partial z} \vert}_{z = 0 +} = \frac{\partial ( {E}_{x}^{i} + {E}_{x}^{r} )}{\partial z} \vert}_{z = 0 -} ⇒ {\sum }_{m = 1} {t}_{m} ( i {β}_{m}^{′} + α ) sin ( {γ}_{m}^{′} y ) = {\sum }_{m = 1} ( i {β}_{m} {a}_{m} - ( i {β}_{m} + α ) {r}_{m} ) sin ( {γ}_{m} y ) . \qquad ( 25 )$$

Continuity of the derivative is only imposed across the shared cross-section (0<x<h_{eff}). Hence, we multiply both sides with

$$\frac{2}{{h}_{eff}} sin ( {γ}_{k} y )$$

and integrate across [0, h_{eff}].

To obtain

$${\sum }_{m = 1} {t}_{m} ( i {β}_{m}^{′} + α ) \frac{2}{{h}_{eff}} {\int }_{0}^{{h}_{eff}} sin ( {γ}_{m}^{′} y ) sin ( {γ}_{k} y ) dy = {\sum }_{m = 1} ( i {β}_{m} {a}_{m} - ( i {β}_{m} + α ) {r}_{m} ) \frac{2}{{h}_{eff}} {\int }_{0}^{{h}_{eff}} sin ( {γ}_{m} y ) sin ( {γ}_{k} y ) dy . \qquad ( 26 )$$

The orthogonality of the eigenmodes implies that

$$\frac{2}{{h}_{eff}} {\int }_{0}^{{h}_{eff}} sin ( {γ}_{m} y ) sin ( {γ}_{k} y ) dy = {δ}_{nk} = \{ \begin{matrix}1 & n = k \\ 0 & n \neq k\end{matrix} . \qquad ( 27 )$$

Finally we obtain the following equation

$${\sum }_{m = 1} {t}_{m} ( i {β}_{m}^{′} + α ) {\underbrace{\frac{2}{{h}_{eff}} {\int }_{0}^{{h}_{eff}} sin ( {γ}_{m}^{′} y ) sin ( {γ}_{k} y ) dy}}_{{l}_{km}^{′}} = ( i {β}_{k} {a}_{k} - ( i {β}_{k} + α ) {r}_{k} ) . \qquad ( 28 )$$

The elements l′ₖₘ can be organized into a matrix L₂ so that

$${L}_{2} = \frac{{h}_{eff}^{′}}{{h}_{eff}} {L}_{1}^{T} .$$

We then define the three following diagonal matrices:

$${D}_{i} = [ \begin{matrix}i {β}_{1} & & \\ & ⋱ & \\ & & i {β}_{m}\end{matrix} ] , {D}_{r} = [ \begin{matrix}i {β}_{1} + α & & \\ & ⋱ & \\ & & i {β}_{m} + α\end{matrix} ] , {D}_{t} = [ \begin{matrix}i {β}_{1}^{′} + α & & \\ & ⋱ & \\ & & i {β}_{m}^{′} + α\end{matrix} ] . \qquad ( 29 )$$

Finally the linear system becomes

$${D}_{i} a = {D}_{r} r + {L}_{2} {D}_{t} t \qquad ( 30 )$$

### Mode Matching Derivation: Towards Thinner Cavity

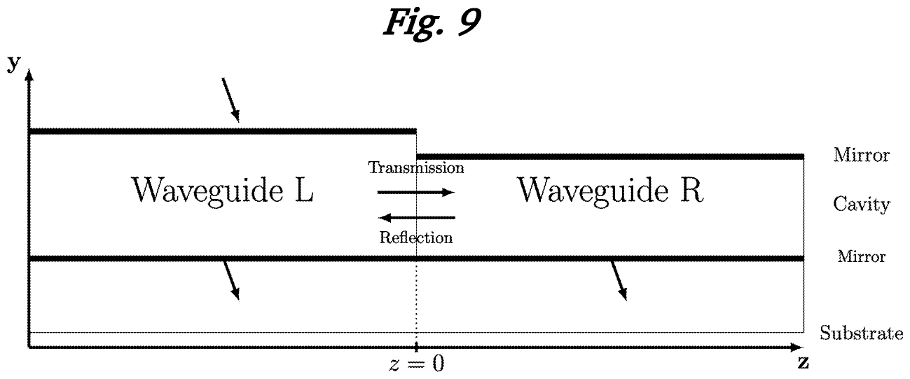

For completeness, we now provide the detailed derivation for going from a thick to thin cavity. FIG. 9 illustrates a configuration of two adjacent parallel plate waveguides, L and R, where crosstalk occurs towards a thinner filter. The main difference is that the edge of the thicker filter that extends beyond the shared cross-section is now on the left side. This implies some changes in the limits of integration of the derivation.

### Boundary Condition 1: Continuity of the Electrical Field

Substituting the modal expansions in the boundary condition gives

$${\sum }_{m = 1} ( {a}_{m} + {r}_{m} ) sin ( {γ}_{m} y ) = \{ \begin{matrix}{\sum }_{m = 1} {t}_{m} sin ( {γ}_{m}^{′} y ) & 0 < x < {h}_{eff}^{′} \\ 0 & else\end{matrix} . \qquad ( 31 )$$

This time the left-side field is thicker and is enforced to be zero above the shared cross section (x>h′_{eff}, see also Eq. (19)).

We proceed by multiplying both sides by

$$\frac{2}{{h}_{eff}}$$

sin(γₖy) and integrating across [0, h_{eff}]. We obtain

$${\sum }_{m = 1}^{M} ( {a}_{m} + {r}_{m} ) \frac{2}{{h}_{eff}^{′}} {\int }_{0}^{{h}_{eff}^{′}} sin ( {γ}_{m} y ) sin ( {γ}_{k} y ) d y = {\sum }_{m = 1}^{M} {t}_{m} \frac{2}{{h}_{eff}^{′}} {\int }_{0}^{{h}_{eff}^{′}} sin ( {γ}_{m}^{′} y ) sin ( {γ}_{k} y ) dy . \qquad ( 32 )$$

From the orthogonality of the modes it follows that

$$( {a}_{m} + {r}_{m} ) = {\sum }_{m = 1}^{M} ( {t}_{m} ) {\underbrace{\frac{2}{{h}_{eff}} {\int }_{0}^{{h}_{eff}^{′}} sin ( {γ}_{m} y ) sin ( {γ}_{k}^{′} y ) dy}}_{{l}_{k m}} . \qquad ( 33 )$$

The factors lₖₘ can again be arranged in a matrix L₁^{T}. The transpose was added to enable generalization. Hence we obtain the following linear matrix equation

$$( a + r ) = {L}_{1}^{T} t \qquad ( 34 )$$

### Boundary Condition 2: Continuity of the Electrical Field Derivative

Substituting the modal expansions into the second boundary condition gives

$$\begin{matrix} & \frac{\partial {E}_{x}^{t}}{\partial 𝓏} {\vert}_{z = 0 +} = \frac{\partial ( {E}_{x}^{i} + {E}_{x}^{r} )}{\partial 𝓏} {\vert}_{z = 0 -} \\ ⇒ & {\sum }_{m = 1} {t}_{m} ( i {β}_{m}^{′} + α ) sin ( {γ}_{m}^{′} y ) = {\sum }_{m = 1} ( i {β}_{m} {a}_{m} - ( i {β}_{m} + α ) {r}_{m} ) sin ( {γ}_{m} y )\end{matrix} \qquad ( 35 )$$

Continuity of the derivative is only imposed across the shared cross-section (0>x>h′_{eff}) (this is the main difference). Hence, we multiply both sides with

$$\frac{2}{{h}_{eff}^{′}}$$

sin(γ′ₖy) and integrate across [0, h′_{eff}] (instead of [0, h_{eff}] as in the previous case). We obtain

$${\sum }_{m = 1} {t}_{m} ( i {β}_{m}^{′} + α ) \frac{2}{{h}_{eff}^{′}} {\int }_{0}^{{h}_{eff}^{′}} sin ( {γ}_{m}^{′} y ) sin ( {γ}_{k}^{′} y ) dy = {\sum }_{m = 1} ( i {β}_{m} {a}_{m} - ( i {β}_{m} + α ) {r}_{m} ) \frac{2}{{h}_{eff}^{′}} {\int }_{0}^{{h}_{eff}^{′}} sin ( {γ}_{m} y ) sin ( {γ}_{k}^{′} y ) dy \qquad ( 36 )$$

From the ortohgonality of the eigenmodes it follows that

$${\sum }_{m = 1} {t}_{m} ( i {β}_{m}^{′} + α ) = ( i {β}_{k} {a}_{k} - ( i {β}_{k} + α ) {r}_{k} ) {\underbrace{\frac{2}{{h}_{eff}^{′}} {\int }_{0}^{{h}_{eff}^{′}} sin ( {γ}_{m}^{′} y ) sin ( {γ}_{k} y ) dy}}_{{l}_{nk}^{′}} . \qquad ( 37 )$$

The factors l′ₖₘ can again be arranged in a matrix L₂^{T}. The transpose was added to enable generalization. Hence we obtain the following linear matrix equation

$${L}_{2}^{T} {D}_{i} a = {L}_{2}^{T} {D}_{r} r + {D}_{t} t . \qquad ( 38 )$$

### Linear System Solution

This section unifies both derivations the provides the linear systems that have to be solved for each case.

First, we redefine the matrices L₁ and L₂ so that

$$\begin{matrix}{[ {L}_{1} ]}_{k m} = \frac{2}{max ( {h}_{eff} , {h}_{eff}^{′} )} {\int }_{0}^{min ( {h}_{eff} , {h}_{eff}^{′} )} sin ( {γ}_{m} y ) sin ( {γ}_{k}^{′} y ) dy , \\ {L}_{2} = \frac{max ( {h}_{eff} , {h}_{eff}^{′} )}{min ( {h}_{eff} , {h}_{eff}^{′} )} {L}_{1}^{T}\end{matrix} \qquad ( 39 )$$

where k and m signify row and column index respectively.

For an increment in cavity height, the M reflection and M transmission coefficients are found as the solution of

$$[ \begin{matrix}- {L}_{1} & {I}_{M \times M} \\ {D}_{r} & {L}_{2} {D}_{t}\end{matrix} ] [ \begin{matrix}r \\ t\end{matrix} ] = [ \begin{matrix}{L}_{1} a \\ {D}_{1} a\end{matrix} ] , \qquad ( 40 )$$

For a decrement in cavity height, the coefficients are the solution of

$$[ \begin{matrix}- {I}_{M \times M} & {L}_{1}^{T} \\ {L}_{2}^{T} {D}_{r} & {D}_{t}\end{matrix} ] [ \begin{matrix}r \\ t\end{matrix} ] = [ \begin{matrix}a \\ {L}_{2}^{T} {D}_{1} a\end{matrix} ] , \qquad ( 41 )$$

which was obtained by following a similar procedure. In these matrices, I_{M×M} indicates the M×M unity matrix.

Finally, we assume that only the fundamental (first) harmonic of the cavity is excited by the incident wave so that

$$a = [ \begin{matrix}1 \\ 0 \\ ⋮ \\ 0\end{matrix} ] . \qquad ( 42 )$$

### Evanescent Crosstalk Condition and Cutoff Angle

There are two ways to eliminate crosstalk. First, by minimizing the transmission coefficients by maximizing the difference in cavity height (to maximally mismatch the modes). When that is not possible, the alternative is to arrange the filters such that the crosstalk in the neighboring filter is evanescent, that is, it dies out quickly.

This section derives the conditions under which crosstalk is evanescent. First, it is derived that crosstalk between filters can only be eliminated asymmetrically through evanescence. Next, an expression is found for the maximum incidence angle at which crosstalk can be eliminated. In what follows, the originating filter will be annotated as “from”, the crosstalk-receiving filter will be annotated as “to”.

### Asymmetric Crosstalk Condition

We want to determine under what conditions the excited mode in the neighboring filter becomes evanescent. We start by observing that in a linear system the frequency of the leaking light remains unchanged. The dispersion relationship for both cavities can hence be equated as

$${( \frac{2 π f}{c} )}^{2} = \frac{1}{{[ {n}_{eff}^{from} ]}^{2}} [ {β}_{from}^{2} + {( \frac{π}{{h}_{eff}^{f r o m}} )}^{2} ] = \frac{1}{{[ {n}_{eff}^{t o} ]}^{2}} [ {β}_{t o}^{2} + {( \frac{π}{{h}_{eff}^{t o}} )}^{2} ] . \qquad ( 43 )$$

This equation holds for both TE and TM modes.

Next, we solve Eq. (43) to the propagation constant βₜₒ of the receiving filter so that

$${β}_{t o} = \sqrt{{[ \frac{{n}_{eff}^{t o}}{{n}_{eff}^{f r o m}} ]}^{2} [ {β}_{f r o m}^{2} + {( \frac{π}{{h}_{eff}^{f r o m}} )}^{2} ] - {( \frac{π}{{h}_{eff}^{t o}} )}^{2}} . \qquad ( 44 )$$

The mode is evanescent when βₜₒ is imaginary. This occurs when

$${β}_{f r o m}^{2} < {[ \frac{{n}_{eff}^{f r o m}}{{n}_{eff}^{t o}} ]}^{2} {( \frac{π}{{h}_{eff}^{t o}} )}^{2} - {( \frac{π}{{h}_{eff}^{f r o m}} )}^{2} . \qquad ( 45 )$$

Since the left hand side is non-negative, the condition can only hold when

$$\begin{matrix} & {[ \frac{{n}_{eff}^{f r o m}}{{n}_{eff}^{t o}} ]}^{2} {( \frac{π}{{h}_{eff}^{t o}} )}^{2} \geq {( \frac{π}{{h}_{eff}^{f r o m}} )}^{2} \\ ⟺ & {n}_{eff}^{f r o m} {h}_{eff}^{f r o m} \geq {h}_{eff}^{t o} {h}_{eff}^{t o} \\ ⟺ & {n}_{eff}^{f r o m} ( \frac{{λ}_{cwl}^{f r o m}}{2 {n}_{eff}^{f r o m}} ) \geq {h}_{eff}^{t o} ( \frac{{λ}_{cwl}^{t o}}{2 {n}_{eff}^{t o}} ) \\ ⟺ & {λ}_{cwl}^{f r o m} \geq {λ}_{cwl}^{t o} .\end{matrix} \qquad ( 46 )$$

In words, cavity crosstalk can only be eliminated when it leaks towards a filter with a shorter central wavelength; at least when only considering the fundamental modes. This is a necessary but insufficient condition: for narrowband Fabry-Pérot filters crosstalk can only be eliminated up to certain angle of incidence. This will be derived in that follows.

### Crosstalk Elimination up to a Cutoff Angle

Light arrives at one filter at a certain angle of incidence θ with respect to the normal. The light then leaks to a neighboring filter. In this section, we determine the maximal incidence angle for which crosstalk is eliminated, or at least suppressed.

The existence of such a maximal incidence angles follows from two facts. First, waveguides have a cutoff frequency and can only propagate modes above that frequency. Second, Fabry-Pérot filters are angle-dependent and the transmitted frequency increases with the incidence angle (sometimes called a “blue shift”). At some angle, the frequency in one cavity will exceed the cutoff frequency of a neighbouring filter such that crosstalk can propagate. The angle at which this occurs will be called the cutoff angle θ_{c}.

The incidence angle θ can be related to the waveguide propagation factor β_{from} by interpreting the latter as the tangential wavevector component (often also called k_{z}) which remains constant in all layers (continuity of the tangential fields). We have that

$${β}_{f r o m} = {\underbrace{\frac{2 π sin θ}{λ}}}_{In vacuum} = {\underbrace{\frac{2 π {n}_{eff}^{f r o m} sin {θ}_{n}}{λ}}}_{In cavity} , \qquad ( 47 )$$

with n_{eff}^{from} sin θₙ=sin θ. The wavelength λ is defined in vacuum.

Substituting Eq. (47) above into Eq. (45) gives

$${[ \frac{2 π {n}_{eff}^{f r o m} sin {θ}_{n}}{λ} ]}^{2} < {[ \frac{{n}_{eff}^{f r o m}}{{n}_{eff}^{t o}} ]}^{2} {( \frac{π}{{h}_{eff}^{t o}} )}^{2} - {( \frac{π}{{h}_{eff}^{f r o m}} )}^{2} . \qquad ( 48 )$$

Solving this equation to the effective cavity thickness of the right filter h_{eff}^{to} gives

$$\begin{matrix} & {[ {h}_{eff}^{t o} ]}^{2} < {[ \frac{{n}_{eff}^{f r o m}}{{n}_{eff}^{t o}} ]}^{2} \frac{1}{{[ \frac{2 {n}_{eff} sin {θ}_{n}}{λ} ]}^{2} + {( \frac{1}{{h}_{eff}^{f r o m}} )}^{2}} \\ ⟺ & {[ {h}_{eff}^{t o} ]}^{2} < {[ \frac{{n}_{eff}^{f r o m}}{{n}_{eff}^{t o}} ]}^{2} \frac{{[ {h}_{eff}^{f r o m} ]}^{2}}{{[ \frac{2 {h}_{eff}^{f r o m} {n}_{eff}^{f r o m} sin {θ}_{n}}{λ} ]}^{2} + 1} .\end{matrix} \qquad ( 49 )$$

By construction we have that

$${h}_{eff} = \frac{{λ}_{cwl}}{2 {n}_{eff}}$$

so that

$$\begin{matrix} & {[ \frac{{λ}_{cwl}^{to}}{2 {n}_{eff}^{to}} ]}^{2} < {[ \frac{{n}_{eff}^{f r o m}}{{n}_{eff}^{t o}} ]}^{2} \frac{{[ \frac{{λ}_{cwl}^{f r o m}}{2 {n}_{eff}^{from}} ]}^{2}}{{[ \frac{2 \frac{{λ}_{cwl}^{f r o m}}{2 {n}_{eff}^{from}} sin {θ}_{n}}{λ} ]}^{2} + 1} \\ ⟺ & {[ {λ}_{cwl}^{to} ]}^{2} < \frac{{[ {λ}_{cwl}^{f r o m} ]}^{2}}{{[ \frac{{λ}_{cwl}^{f r o m} sin {θ}_{n}}{λ} ]}^{2} + 1} .\end{matrix} \qquad ( 50 )$$

For narrowband filters (λ→λ_{cwl}^{from}) that do not spectrally overlap this condition simplifies to

$$\begin{matrix} & \frac{{λ}_{cwl}^{t o}}{{λ}_{cwl}^{f r o m}} < \frac{1}{\sqrt{{sin}^{2} {θ}_{n} + 1}} \\ ⟺ & \frac{{λ}_{cwl}^{t o}}{{λ}_{cwl}^{f r o m}} < \frac{1}{\sqrt{{[ \frac{sin θ}{{n}_{eff}^{f r o m}} ]}^{2} + 1}} .\end{matrix} \qquad ( 51 )$$

We find that crosstalk is evanescent as long as the angle of incidence satisfies

$$\vert θ \vert < {θ}_{c} = Re [ a sin ( {n}_{eff}^{from} \sqrt{{[ \frac{{λ}_{cwl}^{f r o m}}{{λ}_{cwl}^{t o}} ]}^{2} - 1} ) ] , \qquad ( 52 )$$

with θ_{c} defined as the cutoff angle. When λ_{cwl}^{from <λ}_{cwl}^{to}, the square root produces a purely imaginary number (real part is zero). By taking the real part of the angle, we thus make it zero for the λ_{cwl}^{from <λ}_{cwl}^{to} for which crosstalk indeed always propagates.

### Illustration for the Setup in the Paper

The two filters FIG. 1 of the disclosure have central wavelengths λ_{cwl}^{L}=720 nm and λ_{cwl}^{R}=753 nm. Using Eq. (52), the cutoff angle θ_{c}=31.4°.

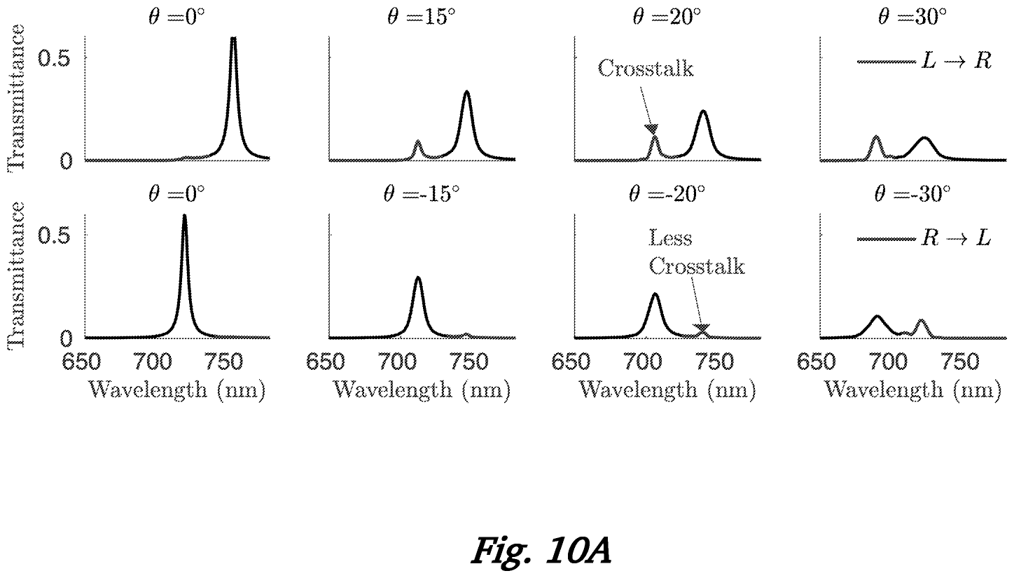

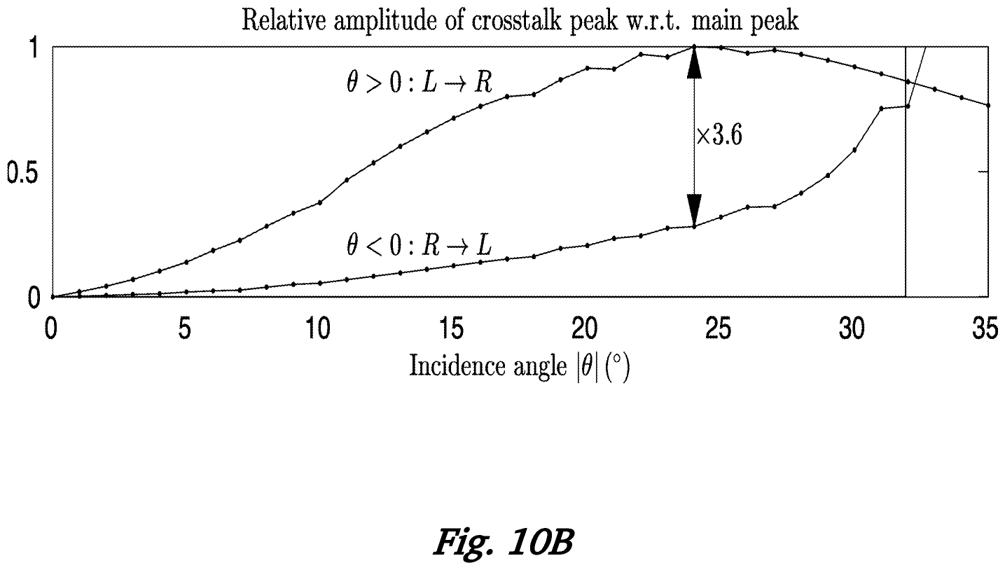

The crosstalk asymmetry and cutoff angle are made visible by plotting the transmittances of the two filters for a range of incidence angles. This is shown in FIG. 10A, 10B, which show that crosstalk can be reduced in one direction below a certain cutoff angle of incidence. FIG. 10A shows graphs of transmittance spectra showing crosstalk asymmetry. FIG. 10B shows a graph of relative height of crosstalk peak transmittance. Below the cutoff angle of about 32°, crosstalk in the R→L direction is much smaller than in the opposite L→R direction, demonstrating asymmetry. The details of the numerical simulation are outlined below.

### Additional Details for the Numerical FDFD Simulation

### Guiding Example With Two Filters

The numerical simulations were performed using a finite-difference frequency-domain (FDFD) Matlab Toolbox, called MaxwellFDFD, which uses a direct solver. We are only interested in the harmonic regime of resonant structures and hence time steps are not required.

Two Fabry-Pérot filters are placed adjacently as in FIG. 1 of the disclosure. Each filter has a standard all-dielectric Fabry-Pérot design:

$$Air \vert {H ( L H )}^{b} \vert {L}_{c} \vert {( HL )}^{b} H \vert \qquad ( 53 )$$

where each layer is a quarter-wave plate for a chosen central wavelength and LH indicates a layer of low and then high refractive index. The exponent in (LH)^{b} indicates this pattern is repeated b times. The three designs are

$$\begin{matrix}Left : & Air \vert {H ( L H )}^{4} L {L ( H L )}^{4} H \vert Substrate \\ Right : & Air \vert {H ( L H )}^{4} {L}^{′} {L ( H L )}^{4} H \vert Substrate\end{matrix} \qquad ( 54 )$$

Where L and H are quarter-wave layers for a central wavelength around λ_{cwl}=720 nm. By construction, this means that the dielectric mirror has a central wavelength around 720 nm. The material parameters that were used are nₐᵢᵣ=1, n_{L}=1.5, N_{H}=2.4, and n_{sub}=3.67. Taking δ_{L}=0 nm and δ_{R}=30 nm, the filters have central wavelengths λ_{cwl}^{L}=720 nm and λ_{cwl}^{R}=753 nm respectively, at normal incidence; all wavelengths are specified in vacuum.

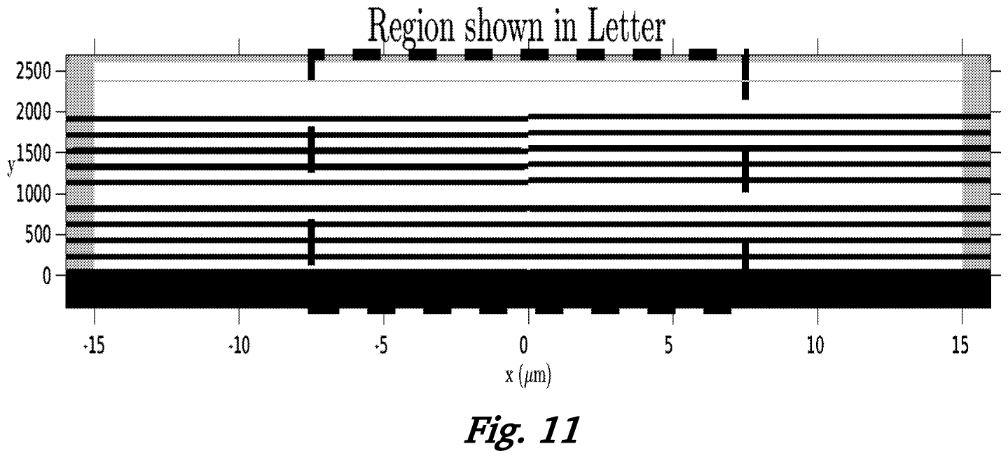

The simulation domain is visualized in FIG. 11, which is a graph of the FDFD simulation domain with two adjacent Fabry-Pérot filters on a single substrate.

The grid size is 50 nm horizontally and 5 nm vertically, which provided a good fit with mode matching model. The perfectly matched layers (PML) are 1000 nm on the left and right border and 100 nm on the top and bottom border. In addition, an s-polarized plane wave source is placed above the filters. To avoid edge effects when approximating semi-infinite filters, the filters were made larger than the region shown in the main paper (dashed).

### Filterbank With Nine Filters

In the discussion above, the crosstalk and performance for three filter patterns is investigated (see FIGS. 5A, 5B, 5C). All three patterns have the same nine different filters but arranged in a different order. From the left to the right, Pattern A ascends in thickness, Pattern B descends and Pattern C maximizes the differences in stepsize.

The filters in the filterbank are of the same design as in Eq. (53). The nine cavity heights increase in steps of 20 nm: 180, 200, 220, 240, 260, 280, 300, 320, 340 nm. Two additional filters are padded with cavity height 160 nm and 360 nm on the left and right respectively. The cavity heights for Pattern C (from left to right) are: 160, 280, 200, 320, 240, 340, 220, 300, 180, 260 nm

The transmittance of each filter is calculated by dividing the transmitted power to the pixel by the incident power in the absence any structures. The power transfer to the pixel is calculated by placing a powerflux patch (MaxwellFDFD) one gridpoint below the filter-substrate interface. This simulation is then repeated for wavelengths ranging from 630 nm to 850 nm. Pattern C was simulated with a horizontal gridsize of 10 nm to get convergent results.

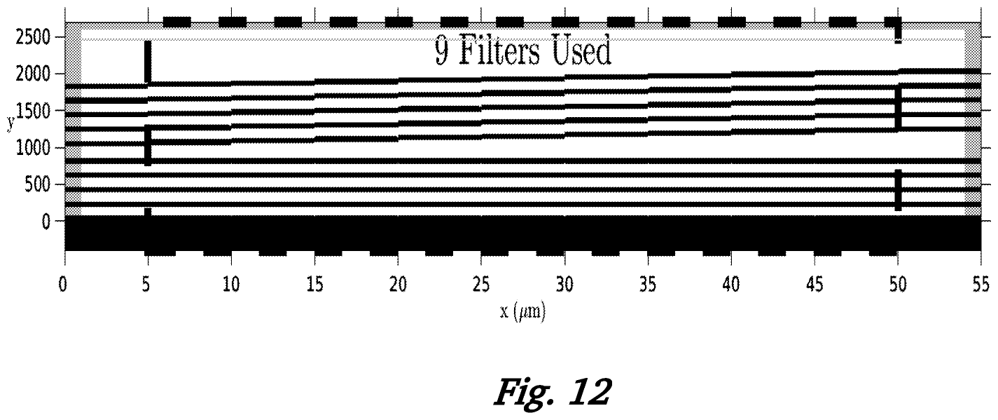

FIG. 12 shows a graph of the FDFD simulation domain with nine adjacent Fabry-Pérot filters on a single substrate. Two additional filters are added on the border as padding.

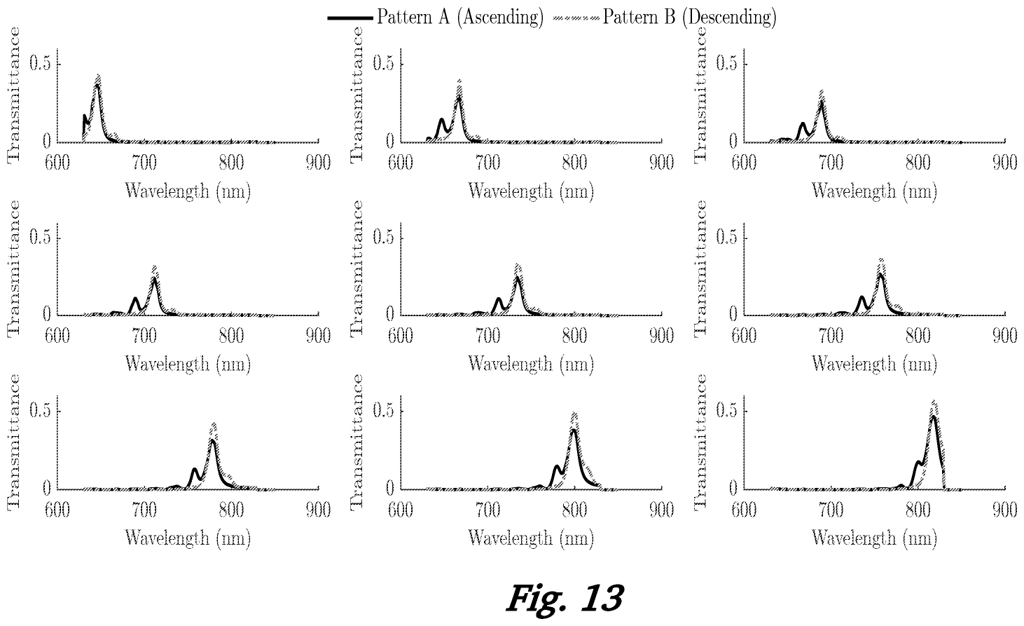

FIG. 13 are graphs showing the transmittance of each filter illuminated at 15° (pattern A) and −15° (pattern B). The transmittance of the nine filters are compared here for pattern A and B. As expected, pattern B suffers less from crosstalk.

### Variations, and Alternate Embodiments

In devices according to the present invention, the preferred pattern to reduce crosstalk between filters is a pattern in which the central wavelengths of filter elements within each of the rectangular cells decrease with distance from the optical axis. It is noted, however, that a small fraction of filters in the array may have fabrication defects, or violate the ideal pattern for other reasons, and yet the filter array overall will still have significant reduction in crosstalk. For example, in some embodiments, as many as 5%, 10%, or even 15% to 20% of the filters might violate the ideal pattern. In other words, it suffices for 80% to 95% or more of the filters to conform to the ideal pattern. It is also noted that the benefits of the ideal pattern are most significant far from the optical axis where the incidence angles are typically largest. Thus, conformation to the ideal pattern is not required for filters near the axis (e.g., where chief ray angles are expected to be less than 10°, and in that central region most or all of the filters may depart from the ideal pattern.

In devices according to the present invention, the filters are fabricated above sensor elements. Although the filters may be fabricated directly on top of the sensor elements, as illustrated in the examples discussed above, it is also possible to fabricate the filters above the sensor elements with one or more intermediate layers between them. For example, the filters may be fabricated directly on a glass substrate which is on top of the sensor element array. It is also possible for the filters to be used in a manner not integrated with the sensor array. For example, the filters and glass substrate may be separated by an air gap from the sensor array. The air gap may even be a significant distance, provided lenses are used to guide the light appropriately through the filters prior to being imaged on the sensor elements. The sensor elements themselves may be any of various types of optical sensors such as, for example, CCD, CMOS, InGaAs based sensors, and single-photon avalanche diodes.

In devices described above, the filters are implemented using two mirrors made of quarter-wave dielectric stacks. Alternatively, it is possible to implement the filters using thin metal layers as the two mirrors.

In devices described above, the filters are tuned to a desired central wavelength by selecting the distance between the mirrors and/or the refractive index of the cavity material. In some implementations, the cavity refractive index can be varied using a non-homogenous layer (e.g., metamaterial, subwavelength pattern). Such a layer can be used to tune the effective refractive index of the cavity layer.

In the above discussion, the central wavelength of a filter is defined as the peak transmitted wavelengths at normal incidence. More generally, the central wavelength is defined as the midpoint between wavelengths of half-maximum transmittance. In many cases this will closely coincide with the wavelength of peak transmittance. Preferred embodiments of the invention would typically be designed to operate with filters having central wavelengths in the optical spectrum, i.e., 100 nm to 1 mm.

1. An integrated spectral imaging device comprising:
(a) a sensor array comprising image sensor elements; and
(b) a filter array comprising Fabry-Pérot optical filter elements;
wherein each of the Fabry-Pérot optical filter elements is fabricated above one of the image sensor elements;
wherein each of the Fabry-Pérot optical filter elements has an optical cavity with an optical path length tuned to a central wavelength;
wherein the Fabry-Pérot optical filter elements are configured such that they are grouped in rectangular cells such that central wavelengths of filter elements within each of the rectangular cells decrease with distance from an optical axis located at a central position in the filter array.

2. The device of claim 1 wherein the cavity has a thickness and a refractive index selected to tune the optical path length of the cavity to the central wavelength.

3. The device of claim 1 wherein the central wavelengths of the filter elements within each of the rectangular cells decrease with distance from the optical axis along two orthogonal axes within a plane of the filter array.

4. The device of claim 1 wherein the central wavelengths of the filter elements within each of the rectangular cells decrease with distance from the optical axis along at least one of two orthogonal axes within a plane of the filter array.

5. The device of claim 1 wherein each of the rectangular cells has at least two filters along each side.

6. The device of claim 1 wherein each of the rectangular cells has at least two filters along each side, wherein adjacent filters in the rectangular cells have distinct central wavelengths.

7. The device of claim 1 wherein the Fabry-Pérot optical filter elements are substantially contiguous, and wherein the image sensor elements are substantially contiguous.

8. The device of claim 1 wherein the Fabry-Pérot optical filter elements are configured with gaps between adjacent elements, wherein the gaps are at most 1 μm.

9. The device of claim 1 wherein each of the image sensor elements has a shortest dimension no more than 100 μm wide.

10. The device of claim 1 wherein each of the Fabry-Pérot optical filter elements is fabricated above a plurality of the image sensor elements.

11. The device of claim 1 wherein each of the Fabry-Pérot optical filter elements has multiple optical cavities.
